(19) United States
(12) Patent Application Publication
(10) Pub. No.: US 2023/0026955 A1
(43) Pub. Date: Jan. 26, 2023

(54) DISPOSABLE STENCIL TOOL

(71) Applicant: Yi XU, Calgary (CA)

(72) Inventor: Yi XU, Calgary (CA)

(21) Appl. No.: 17/381,295

(22) Filed: Jul. 21, 2021

(51) Int. Cl. B41L 13/06; B41L 13/12; B41L 13/14

(52) U.S. Cl. CPC B41L 13/06; B41L 13/12; B41L 13/14

(57) ABSTRACT

A disposable stencil tool is provided. A disposable stencil tool for marking a foil, comprising a flexible sheet with holes, the holes forming an outline wherein the flexible sheet may be coupled to the foil, the holes allowing a user to mark the foil with the outline, the outline for fitting a joint between a plurality of tubular members. A method of employing the disposable stencil tool, to mark foil, the method comprising coupling the flexible sheet to the foil and marking the outline on the foil through the holes. The method further comprising uncoupling the flexible sheet from the foil and cutting the foil along the outline forming a cut edge on an end of the foil. The method further comprising fitting the cut edge into the joint and attaching the foil to at least one of the plurality of tubular members.

### FIELD OF THE INVENTION

The present disclosure relates to a stencil more specifically, but not by way of limitation, more particularly to a stencil tool for marking a foil, such as metal foil.

### BACKGROUND

Any discussion of the related art throughout the specification should in no way be considered as an admission that such related art is widely known or forms part of common general knowledge in the field.

Currently there exists no tool on the market to easily determine the shape, and subsequently easily create an outline to cut a foil to fit a joint between tubular members, for example, cutting a metal foil to cover insulation on a T-pipe. Currently, a common technique for a person who wishes to cut said metal, often used by insulation installers for example, is to cut the metal free hand, fitting the metal and the appropriate cut shape on the fly, without an outline, which can be very time consuming.

U.S. Pat. No. 5,626,444 A (Campian) discloses a rotary cutting tool particularly adapted for cutting plastic material. Shortcomings include that a cutting tool is disclosed and said tool does not aid with marking and cutting foil in an appropriate outline, such that it may be fitted to a pipe, for example.

U.S. Pat. No. 6,561,063 B1 (Mulford et al.) discloses a hand-held rotary cut-off tool. Shortcomings include that the disclosed tool does not aid with marking and cutting foil in an appropriate outline, such that it may be fitted to a pipe, for example.

U.S. Pat. No. 6,935,814 B2 (Nagaya et al.) discloses a throwaway cutting tool. Shortcomings include that the disclosed tool does not aid with marking and cutting foil in an appropriate outline, such that it may be fitted to a pipe, for example.

U.S. Pat. No. 9,463,531 B2 (Gey et al.) discloses a method for forming the cutting edge and adjacent contoured surface area of rotary cutting tools utilizing a laser to remove material from the cutting end of the tool to create a predetermined point-by-point geometry. Shortcomings include that the disclosed method is not directed towards and does not aid with marking and cutting foil in an appropriate outline, such that it may be fitted to a pipe, for example.

U.S. Pat. No. D519,531 S1 (Kobashi) discloses an ornamental design of a cutting tool. Shortcomings include that the disclosed design of a cutting tool does not aid with marking and cutting foil in an appropriate outline, such that it may be fitted to a pipe, for example.

U.S. Pub. No. 2006/0130338 A1 (Dzubak et al.) discloses a disposable box cutter which is a handheld cutting tool. Shortcomings include that the disclosed tool does not aid with marking and cutting foil in an appropriate outline, such that it may be fitted to a pipe, for example.

U.S. Pub. No. 2009/0022561 A1 (Winebrenner) discloses a rotary cutting tool especially adapted for cutting composite materials. Shortcomings include that the disclosed tool does not aid with marking and cutting foil in an appropriate outline, such that it may be fitted to a pipe, for example.

CN Pat. No. 105,682,833 B (Tomoda et al.) discloses a disposable cutter with a blade containing diamond, with excellent chip treatability. Shortcomings include that the disclosed tool does not aid with marking and cutting in foil an appropriate outline, such that it may be fitted to a pipe, for example.

DE Pat. No. 102,009,051,685 A1 (Baur, Jakob) discloses a device for cutting insulating material, in particular for cutting mineral, stone or glass wool, as a particularly critical example of insulating materials formed with fibers. Shortcomings include that the disclosed tool does not aid with marking and cutting foil in an appropriate outline, such that it may be fitted to a pipe, for example.

JP Pat. No. 2018-187,757 A (Tien, Chang Hsin) discloses a disposable cutting tool, and more particularly, a disposable cutting tool for performing deburring, trimming and chamfer milling of a workpiece. Shortcomings include that the disclosed tool does not aid with marking and cutting foil in an appropriate outline, such that it may be fitted to a pipe, for example.

Further, many existing cutting tools and/or methods, including but not limited to the prior art above, may not be cost effective, nor time effective.

All documents cited herein are incorporated by reference.

It is clear that there exists a need for a disposable stencil tool for marking a foil, such as a metal foil. There is a need for such a tool that can aid with marking and cutting foil in an appropriate outline, such that it may be fitted to a pipe, for example. There is also a need for such a stencil tool to be cost effective and time effective.

Applicant proposes a stencil tool for marking a foil that overcomes disadvantages inherent in the existing tools, such as, but not limited to, a lack of cost effective and time affective aids for marking and cutting foil in an appropriate outline, among others. The present invention provides a stencil tool that may be cost effective, time effective, and allow for marking and cutting foil in an appropriate outline such that it may be fitted to a pipe, for example, among other benefits. As such, the general purpose of the present invention, which will be described subsequently in greater detail, is to provide a new and improved stencil tool for marking a foil, which provides the advantages and overcomes the aforementioned disadvantages.

### BRIEF SUMMARY

It is an object of the invention to provide a disposable stencil tool.

In accordance with an aspect of the invention there is provided a disposable stencil tool for marking a foil, comprising a flexible sheet with holes, the holes forming an outline wherein the flexible sheet may be coupled to the foil, the holes allowing a user to mark the foil with the outline, the outline for fitting a joint between a plurality of tubular members.

In accordance with another aspect of the invention there is provided a method of employing the disposable stencil tool, as described above, to mark foil, the method comprising coupling the flexible sheet to the foil and marking the outline on the foil through the holes.

In accordance with an additional aspect of the invention there is provided a method of employing the disposable stencil tool, as described above, to mark foil, the method further comprising uncoupling the flexible sheet from the foil and cutting the foil along the outline forming a cut edge on an end of the foil.

In accordance with an additional aspect of the invention there is provided a method of employing the disposable stencil tool, as described above, to mark foil, the method further comprising fitting the cut edge into the joint and attaching the foil to at least one of the plurality of tubular members.

In accordance with an additional aspect of the invention there is provided the disposable stencil tool, as described above, wherein the disposable stencil tool is constructed from recyclable materials.

In accordance with an additional aspect of the invention there is provided the disposable stencil tool, as described above, wherein the disposable stencil tool is constructed from compostable materials.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIG. 1 illustrates an example stencil tool, according to some embodiments.

FIG. 2 illustrates a stencil tool applied to mark a metal foil, according to some embodiments.

FIG. 3 illustrates a marked metal foil, according to some embodiments.

FIG. 4 illustrates a cut and secured metal foil, according to some embodiments.

FIG. 5 illustrates a metal foil fitted on a T-Bar, according to some embodiments.

FIG. 6 illustrates a front view of a metal foil fitted on a T-Bar, showing an example foil cut shape, according to some embodiments.

FIG. 7 illustrates a front view of a metal foil fitted on a T-Bar, showing an example foil cut shape, according to some embodiments.

FIG. 8 illustrates a front view of a metal foil fitted on an angled joint, showing an example foil cut shape, according to some embodiments.

FIG. 9 illustrates a front view of a metal foil fitted on an example joint, showing an example foil cut shape, according to some embodiments.

FIG. 10 illustrates a front view of a metal foil fitted on an example joint, showing an example foil cut shape, according to some embodiments.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The present invention describes a stencil tool for marking a foil, that overcomes disadvantages inherent in the known methods and systems of cutting and stenciling. The present invention provides a stencil tool that may be cost effective, time effective, and allow for marking and cutting foil in an appropriate outline such that it may be fitted to a pipe, for example, among other benefits. As such, the general purpose of the present invention, which will be described subsequently in greater detail, is to provide a new and improved stencil tool for marking a foil, which provides the advantages and overcomes the aforementioned disadvantages.

A disposable stencil tool for marking a foil is presented herein. The disposable stencil tool comprises a flexible sheet with holes, the holes forming an outline, wherein the flexible sheet may be coupled to the foil, the holes allowing a user to mark the foil with the outline, the outline for fitting a joint between a plurality of tubular members.

A method of employing the stencil tool to mark foil is presented herein. The method comprises coupling the flexible sheet to the foil and marking the outline on the foil through the holes. In some embodiments, the method further comprises uncoupling the flexible sheet from the foil and cutting the foil along the outline forming a cut edge on an end of the foil. In some embodiments, the method further comprises fitting the cut edge into the joint and attaching the foil to at least one of the plurality of tubular members.

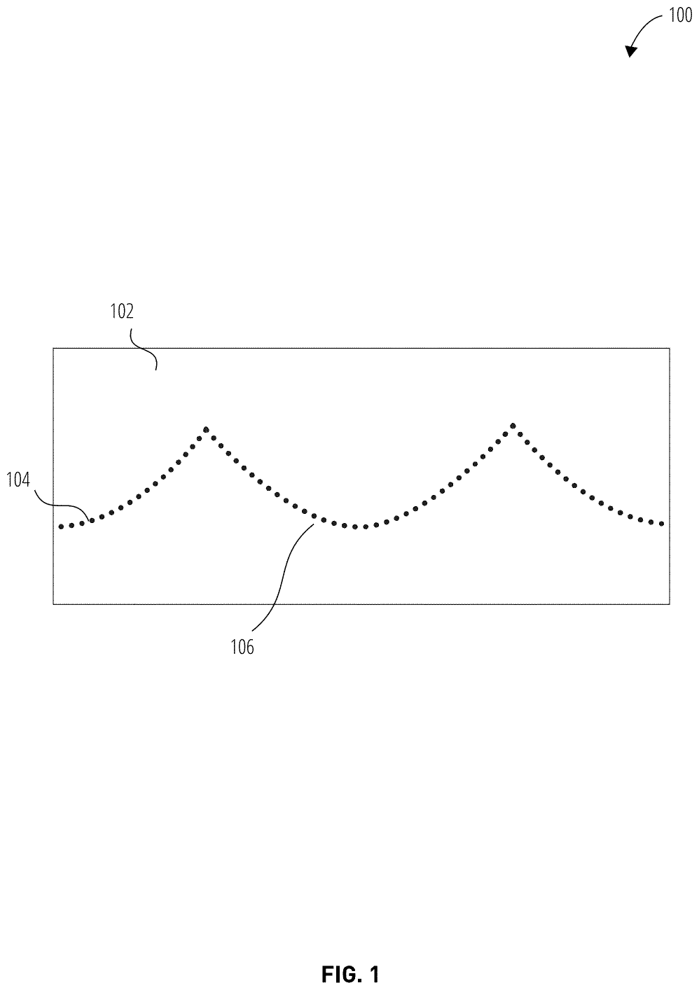

FIG. 1 illustrates an example of a stencil tool 100, according to some embodiments. The stencil tool 100 may have a body, flexible sheet 102, with holes 104. In some embodiments, the holes 104 may be formed to create an outline 106 of an appropriate shape. In some embodiments, the stencil tool 100 may be temporarily fastened with a flexible sheet 102 coupled to a metal foil, wrapping around the metal foil, such that markings may be made through the holes 104, indicating to a user where said user may cut on the metal foil. Said user may remove the stencil tool 100 and cut the metal foil along the markings of outline 106 on the metal foil. After the stenciling and cutting has been completed, the cut metal foil may be placed onto a T-pipe or rolled onto a pipe portion or pipe joint as may be needed, in some embodiments. The stencil tool 100 may have standard cut outlines for common pipe joints, some of which are shown below in some example embodiments.

As a non-limiting example, an insulation installer may wish to fit metal foil around the insulation on a T-pipe. This may be to protect the insulation, for instance. Said user may temporarily fasten or couple a stencil tool 100 to the metal foil, wrapping the flexible sheet 102 around the portion in which the user wishes to cut. Using a pen or a marker, for example, said user may mark through holes 104, marking out outline 106 on the metal foil. Said user may uncouple the stencil tool 100, and use said markings to cut along the outline on the metal foil, such that the metal foil may be fitted around the insulation on the T-pipe. Said user may cut along the created outline on the metal foil by hand or may use a machine.

In some embodiments the stencil tool 100 may be used for insulation, as an example, across many different types of pipes, 90 degree, 45 degree, among other joints. In some embodiments, the outline 106 may be different shapes to accommodate such different types of pipes, and pipe joints.

The stencil tool 100 may allow metal foil, among other materials, to be cut much more quickly than traditional methods, around thirty minutes in many cases, for example. In some embodiments, the stencil tool 100 may provide such ease-of-use that an apprentice of an insulation installer may use said tool to cut metal foil, such that the metal foil may fit properly to insulation around a joint.

In some embodiments, the stencil tool 100 may be used on a flat surface, such as non-rolled sheet-metal. However, in a typical job site of an insulation installer for example, the metal foil may already be rolled. The stencil tool 100 may be flexible, so that the flexible sheet 102 may be wrapped around the metal foil. In some embodiments, the stencil tool 100 is constructed from recyclable materials. In some embodiments, the stencil tool 100 is constructed from compostable materials.

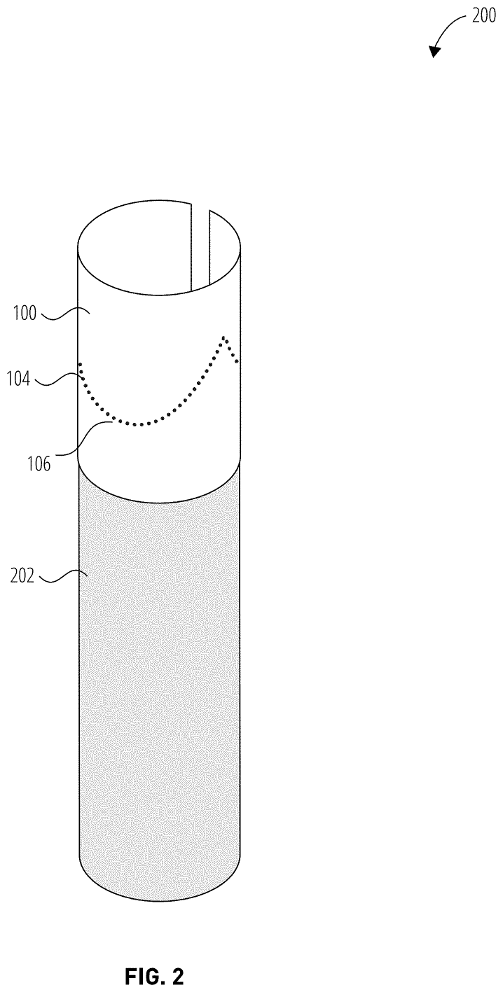

FIG. 2 illustrates a stencil tool applied to mark a metal foil 200, according to some embodiments.

In some embodiments, the stencil tool 100 may be coupled to an outer-side of a metal foil 202, where the stencil tool 100 wraps around the metal foil 202. This may allow a user to mark, through the holes 104 onto the metal foil 202, an outline 106.

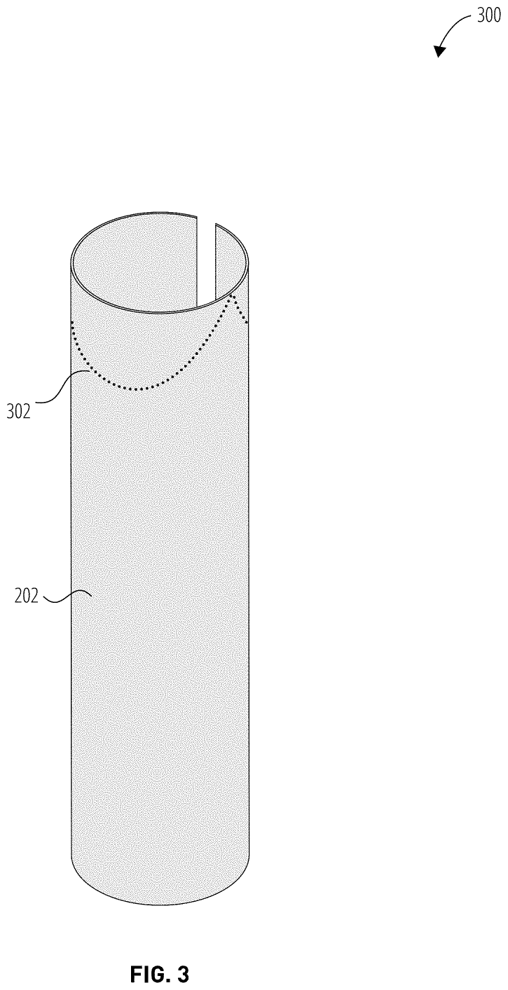

FIG. 3 illustrates a marked metal foil 300, according to some embodiments. In some embodiments, a stencil tool 100 for example, may be used to mark metal foil 202 with an outline 106, as shown with a stencil tool applied to mark a metal foil 200 in FIG. 2.

In some embodiments, the metal foil 202 may be marked, forming a marked outline 302 which may be in a similar or a same shape as the outline 106 used to create the marks. In some embodiments, the metal foil 202 may be cut along the marked outline 302, for example.

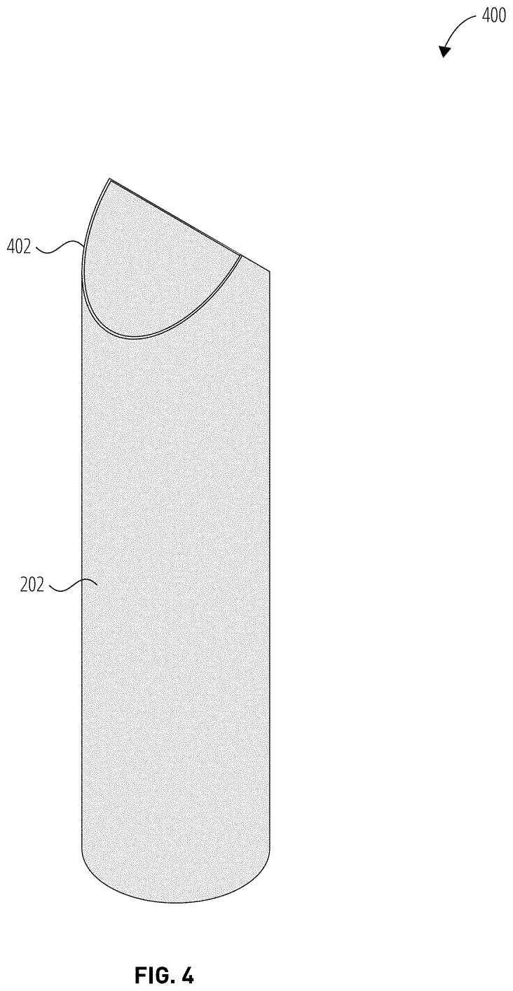

FIG. 4 illustrates a cut metal foil 400, according to some embodiments. Metal foil 202 may be cut, along the marked outline 302, for instance, creating a cut edge 402, forming a desired shape, such that the metal foil 202 may be fit to a T-pipe, for example.

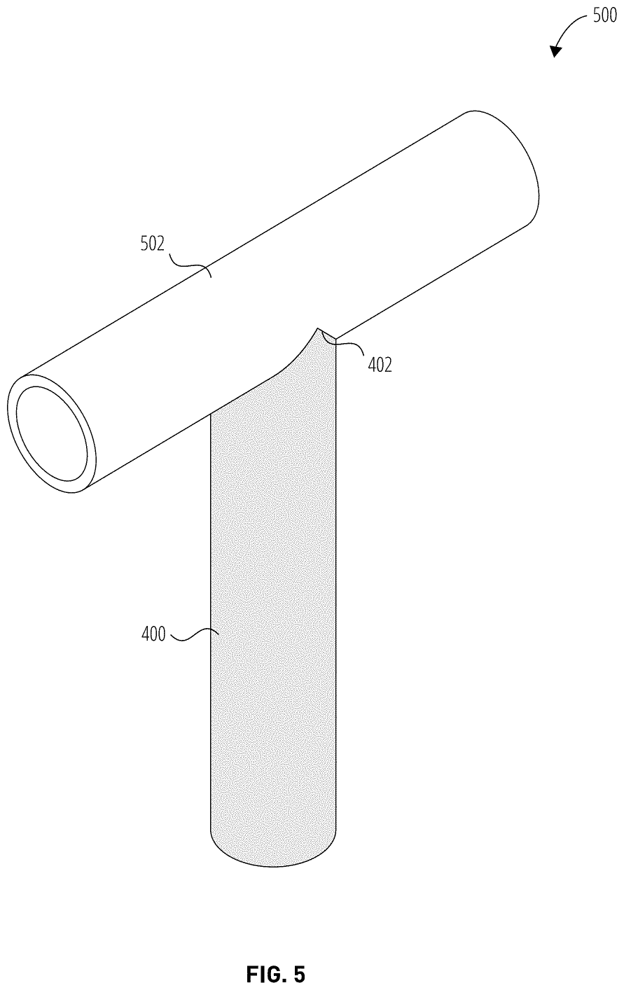

FIG. 5 illustrates a metal foil fitted on T-pipe 500, according to some embodiments. In some embodiments, cut metal foil 400 may be fitted on a T-pipe 502.

As a non-limiting example, a user may have selected a stencil tool 100 with an appropriate outline 106 for proper fitting to a T-pipe, such as T-pipe 502. Said user may have used said stencil tool 100 to mark and cut a metal foil 202 along marked outline 302, creating cut metal foil 400. Fitting cut edge 402 into a joint as appropriate, cut metal foil 400 may then be attached to cover and protect insulation on a T-pipe 502, for instance.

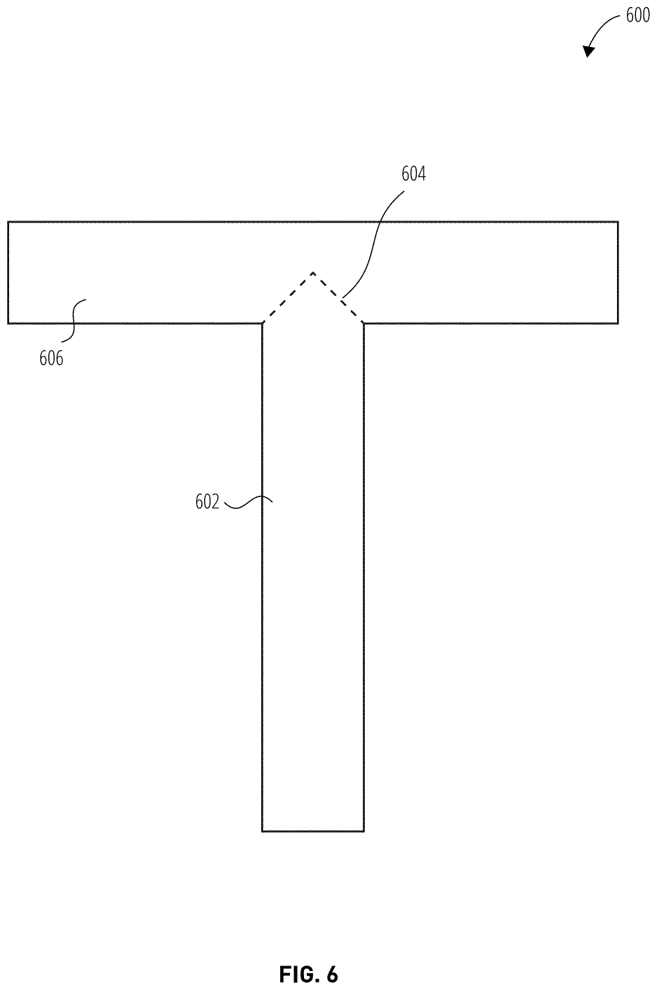

FIG. 6 illustrates a front view 600 of a metal foil fitted on a T-Bar, showing an example foil cut shape, according to some embodiments. Cut metal foil 602 may, in some embodiments, have 90 degree fitted cut edge 604 such that cut metal foil 602 may be attached with a proper fitting to a T-pipe 606.

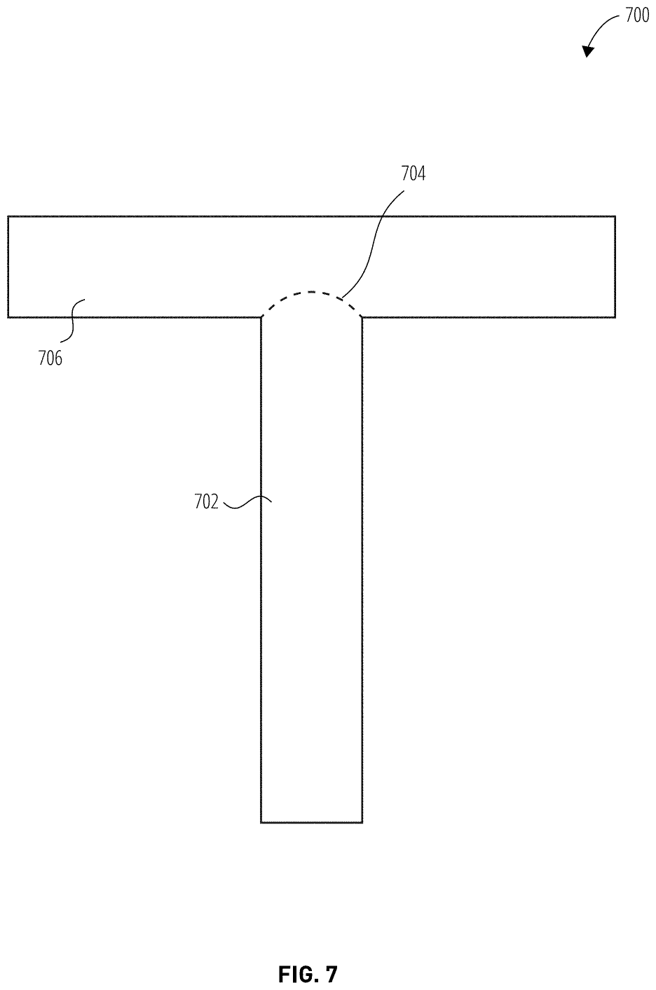

FIG. 7 illustrates a front view 700 of a metal foil fitted on a T-Bar, showing an example foil cut shape, according to some embodiments. Cut metal foil 702 may, in some embodiments, have curved 90 degree fitted cut edge 704 such that cut metal foil 702 may be attached with a proper fitting to a T-pipe 706.

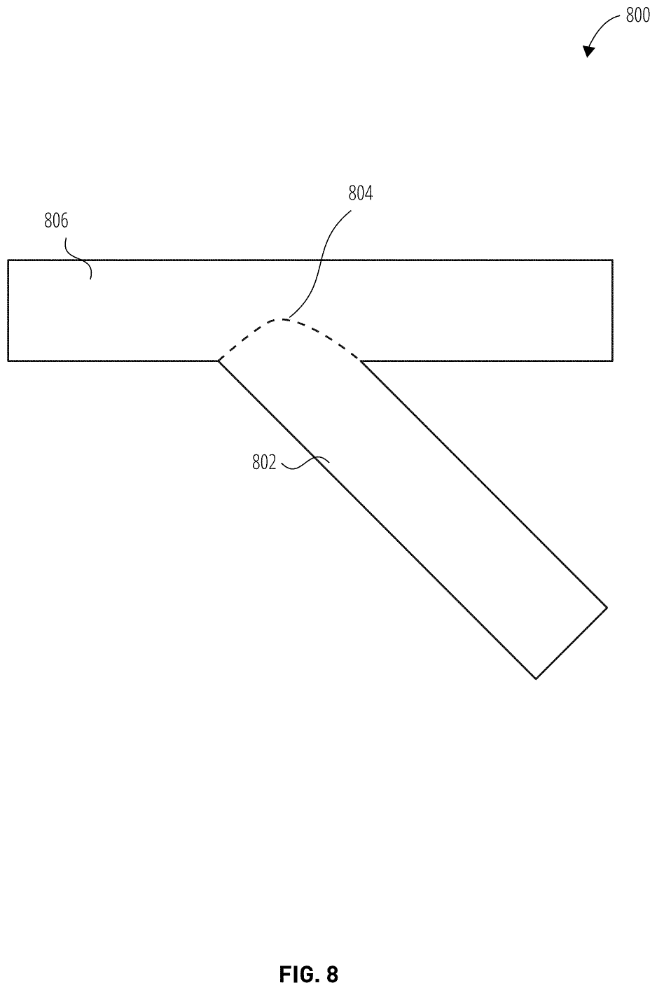

FIG. 8 illustrates a front view 800 of a metal foil fitted on an angled joint, showing an example foil cut shape, according to some embodiments. Cut metal foil 802 may, in some embodiments, have angled fitted cut edge 804 such that cut metal foil 802 may be attached with a proper fitting to a pipe 806, which may be jointed at an angle. In the shown embodiment, angled fitted cut edge 804 may be for 45 degree angle joint at pipe 806. In alternate embodiments, cut metal foil 802 may have an angled fitted cut edge 804 for the appropriate angle, for an appropriate use on an angled pipe 806.

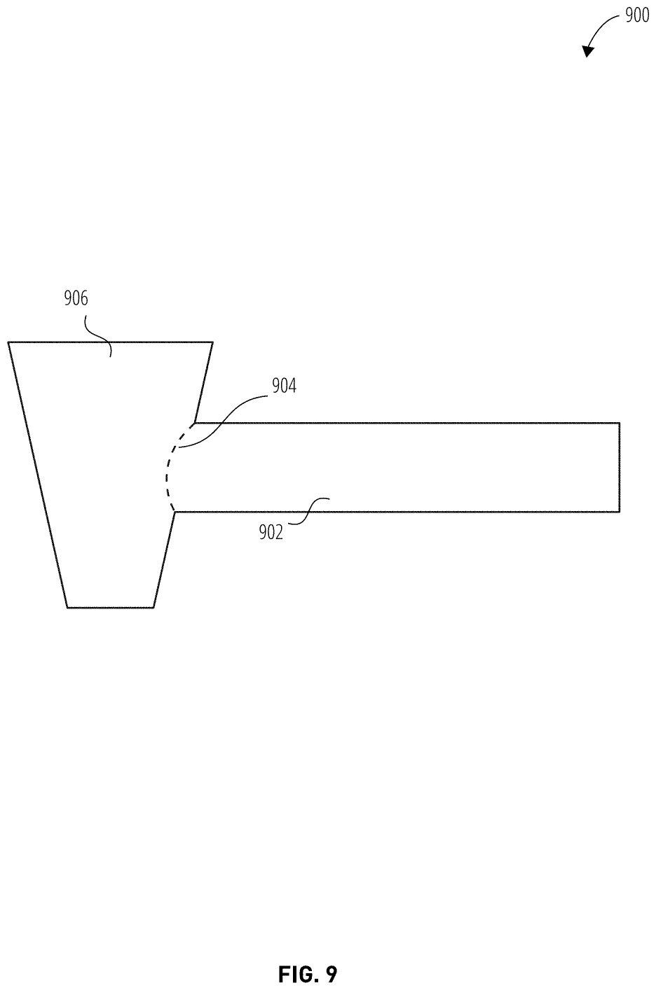

FIG. 9 illustrates a front view 900 of a metal foil fitted on an example joint, showing an example foil cut shape, according to some embodiments. The cut metal foil 902 may, in some embodiments, have a fitted cut edge 904 such that the cut metal foil 902 may be attached with a proper fitting to a pipe 906. As shown, the pipe 906 may have an irregular shape, other than a traditional cylindrical pipe.

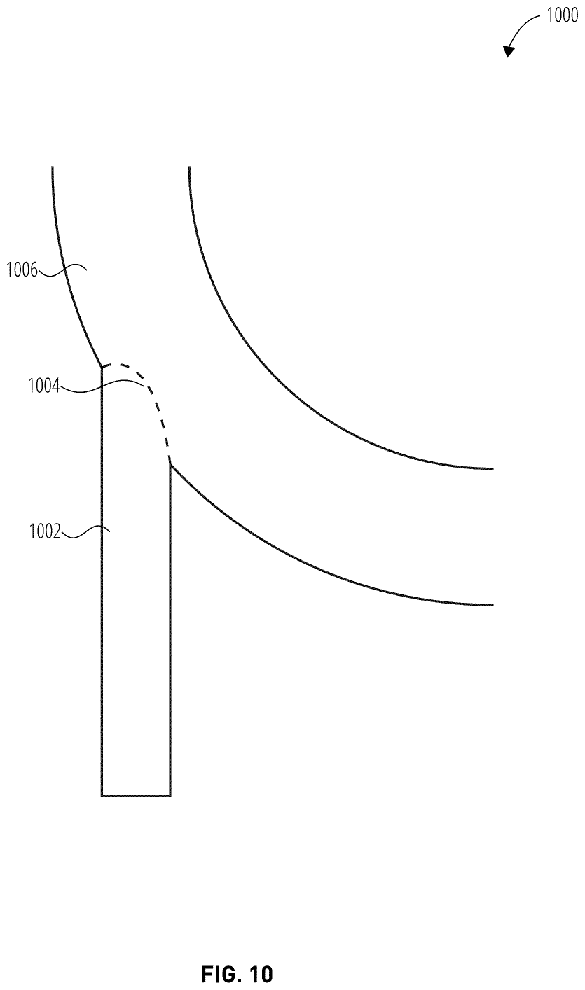

FIG. 10 illustrates a front view 1000 of a metal foil fitted on an example joint, showing an example foil cut shape, according to some embodiments. The cut metal foil 1002 may, in some embodiments, have a curved pipe fitted cut edge 1004 such that the cut metal foil 1002 may be attached with a proper fitting to a curved pipe 1006. In some embodiments, the curved pipe 1006 may be different shapes or curves.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A disposable stencil tool and a metal foil for marking said foil to be cut to fit a pipe, comprising:
a flexible sheet with holes, said holes having standard cut outlines;
wherein said flexible sheet is coupled to said metal foil, said holes allowing a user to mark said metal foil with said standard cut outlines for cutting said metal foil along said standard cut outlines and attaching said metal foil to said pipe.

2. The disposable stencil tool of claim 1, wherein said disposable stencil tool is
constructed from recyclable materials.

3. The disposable stencil tool of claim 1, wherein said disposable stencil tool is
constructed from compostable materials.

4. A method of employing the disposable stencil tool of claim 1, to mark foil, said method
comprising:
coupling said flexible sheet to said foil;
and marking said outline on said foil through said holes.

5. The method of employing the disposable stencil tool of claim 4, further comprising:
uncoupling said flexible sheet from said foil;
and cutting said foil along said outline forming a cut edge on an end of said foil.

6. The method of employing the disposable stencil tool of claim 5, further comprising:
fitting said cut edge into said joint;
and attaching said foil to at least one of said plurality of tubular members.

7. The disposable stencil tool of claim 1, wherein said metal foil is attached to a joint of said pipe between a plurality of tubular members.

8. The disposable stencil tool of claim 1, wherein said metal foil is attached to insulation surrounding said pipe.

9. The disposable stencil tool of claim 1, wherein said metal foil is attached to insulation surrounding said pipe at a joint of said pipe between a plurality of tubular members.

10. The disposable stencil tool of claim 9, wherein said metal foil is attached to cover and protect said insulation surrounding said pipe at a joint of said pipe between a plurality of tubular members.
